(19) United States
(12) Patent Application Publication
(10) Pub. No.: US 2010/0326594 A1
(43) Pub. Date: Dec. 30, 2010

(54) SYSTEM AND METHOD FOR APPLYING ADVERTISEMENT LOGOS AND COLOR SCHEMES TO HOSES

(76) Inventors: Michael A. Ferraro, Wellington, FL (US); Frank C. Ferraro, Wellington, FL (US)

Correspondence Address: GREENBERG TRAURIG, LLP (DC/ORL), 2101 L Street, N.W., Suite 1000, Washington, DC, 20037, US

(21) Appl. No.: 12/774,506

(22) Filed: May 5, 2010

Related U.S. Application Data
(60) Provisional application No. 61/175,572, filed on May 5, 2009.

(51) Int. Cl. B32B 38/14

(52) U.S. Cl. 156/277

(57) ABSTRACT

A manufacture and method for applying advertising logos and color schemes to hoses, such as garden hoses and utility hoses. Sports teams, universities, corporations and other entities may be promoted by advertising their logos upon such hoses. The logos may be stamped or printed upon the hose. The logos may be applied via printing and clear-coating, a shrink-wrap sleeve for the hose, or a stretchable fabric sleeve.

This application claims priority to U.S. Provisional Patent Application No. 61/175,572 filed May 5, 2009, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

This invention pertains to a method and manufacture for advertising on hoses or utilizing hoses for advertising and branding purposes. More specifically, the invention pertains to a method and manufacture for advertising or promoting a company, sports team or other entity using logos or color schemes on hoses such as garden hoses and utility hoses.

### SUMMARY OF THE INVENTION

A method for manufacturing a hose, such as a garden hose, utility hose, or the like includes the steps of stamping or printing a logo or color scheme of a sports team, university, corporation or other entity onto a sleeve and applying the sleeve to the outer surface of the hose.

The invention further includes a method for manufacturing a hose that includes the steps of stamping or printing a logo of a sports team, university, corporation or other entity onto an exterior surface of said garden hose, and applying a clear coating over said imprinted logo.

### BRIEF DESCRIPTION OF THE DRAWINGS

FIG. 1 shows an example of an embodiment of the hose in accordance with the present invention, wherein the logo has a rectangular shape;

FIG. 2 shows an example of another embodiment of the hose in accordance with the present invention, wherein the logo has a circular shape;

FIG. 3 shows an example of an embodiment of the garden hose in accordance with the present invention, wherein the logo represents a sports team.

FIG. 4 shows an example of a garden hose in accordance with another embodiment of the invention.

### DETAILED DESCRIPTION OF THE INVENTION AND THE PREFERRED EMBODIMENTS

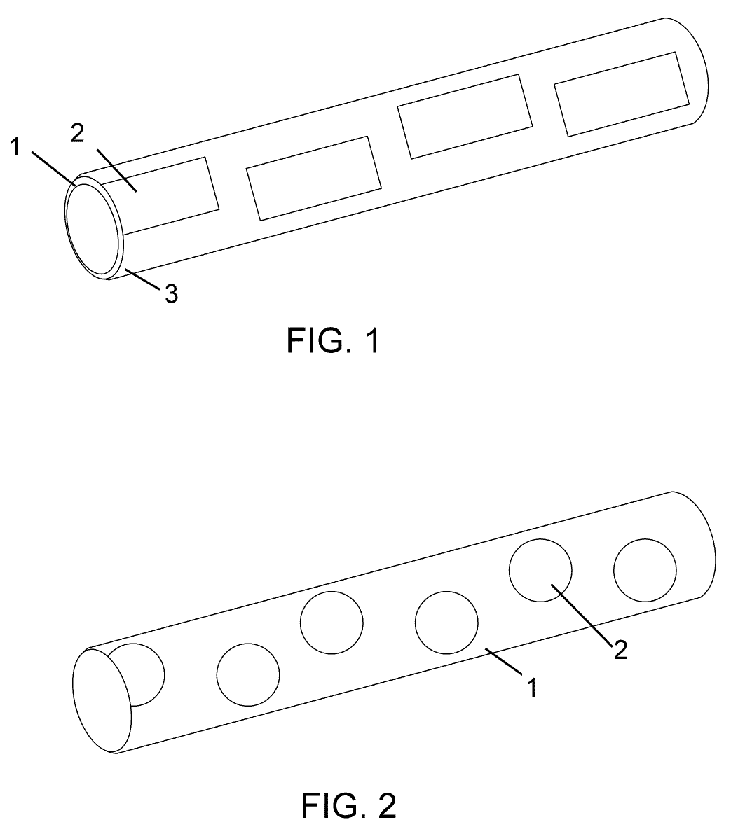

With reference to FIGS. 1 and 2, the presently disclosed invention provides a method to alter the appearance of a hose 1 so that advertisements or promotions of a company or sports logo 2, which may comprise a color scheme, would be represented on the exterior of the hose 1. According to certain embodiments of the invention, the hose 1 is a garden hose.

The logo 2 may represent sports teams from various associations, including but limited to the following: NFL, MLB, NCAA, and NASCAR. In the alternative, the logo 2 may represent companies, such as Harley Davidson, Titleist, etc., or other entities. Various other trademarks, trade names, symbols, labels, images, and designs may be used as a logo 2.

The logo 2 may be permanently affixed or imprinted on the hose 1 itself. For example, the logo 2 may be stamped upon the hose 1. According to one embodiment, the process may include stamping the logo 2 on a lay line of the hose 1 and covering the lay line with a protective coating, such as a clear coating.

The logo 2 may be permanently affixed or imprinted on the hose via ink processing steps similar to those performed by an inkjet printer. The imprinting may be in single or multiple colors, e.g., four-color.

In some embodiments, the logo 2 is applied in an after market process. The logo 2 may be applied as a clear coat “add on” to the hose 1. Alternatively, the logo 2 may be encased as an add-on sleeve 3 for the hose 1. The sleeve may be a shrink wrap. The sleeve 3 may be stretchable fabric of synthetic cloth material, such as polyester, nylon, or Lycra (Spandex). Such after market applications may have the same effect and purpose as the stamped hoses 1, which is to be used for marketing and promotions.

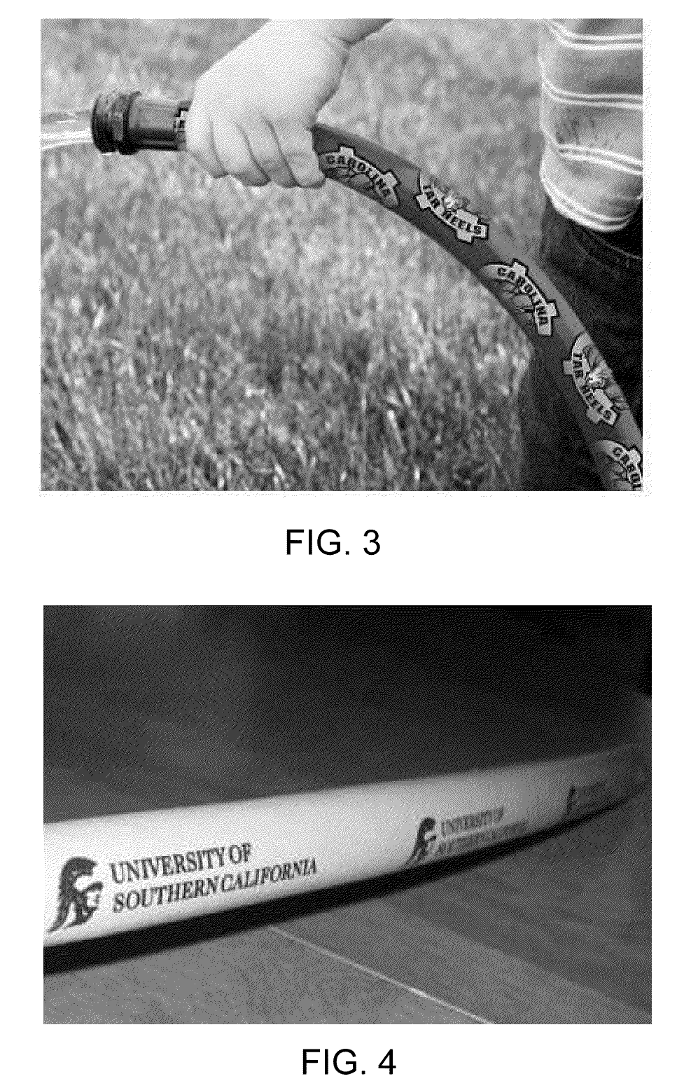

Embodiments of the invention may vary by the size, shape, number of the logos 2 displayed upon the hose 1. FIG. 1 and FIG. 2 represent embodiments wherein the logos 2 have a rectangular shape and/or a circular shape, respectively. It will be apparent to one of skill in the art that almost infinite variations and combinations of shapes and sizes are possible. In addition, the patterns of the logos 2 may vary. For example, such patterns may be random, aligned, or zigzagged. FIG. 3 shows a photograph of an embodiment of a garden hose 1 which has logos 2 that represent a sports team.

There are three ways to the hose in accordance with the invention. First, the logos may be applied as a coating after the final step in the manufacturing process. Second, the logos may be applied to a sleeve of stretchable fabric material, such as synthetic cloth materials including polyester, nylon and lycra (spandex). The material may have UV protection. Third, the application of the logo may be performed as part of the original hose manufacturing process.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention, and has disclosed the ways the inventor now believes are the best ways to practice the invention. The most obvious variations to the present invention include variation in the placement or orientation of the logos 2. It is understood that the above description and drawings are merely illustrative of the present invention and that changes in components, structure and procedure are possible without departing from the scope of the present invention.

What is claimed is:

1. A method of manufacturing a hose, comprising the steps of:
stamping or printing a logo or color scheme of a sports team, university, corporation or other entity onto a sleeve; and,
applying the sleeve to the outer surface of the hose.

2. The method of manufacturing a hose in accordance with claim 1, wherein said sleeve comprises a shrink-wrap sleeve.

3. The method of manufacturing a hose in accordance with claim 1, wherein said sleeve comprises a stretchable fabric sleeve.

4. The method of manufacturing a hose in accordance with claim 3, wherein said stretchable fabric comprises a synthetic cloth material.

5. The method of manufacturing a hose in accordance with claim 4, wherein said synthetic cloth material comprises polyester.

6. The method of manufacturing a hose in accordance with claim 4, wherein said synthetic cloth material comprises nylon.

7. The method of manufacturing a hose in accordance with claim 4, wherein said synthetic cloth material comprises lycra.

8. A method for manufacturing a hose, comprising the steps of:
stamping or printing a logo of a sports team, university, corporation or other entity onto an exterior surface of said hose; and,
applying a clear coating over said imprinted logo.

9. The method for manufacturing a hose in accordance with claim 8, wherein said steps of applying a coating and stamping or printing are performed after an original hose manufacturing process.

10. The method for manufacturing a hose in accordance with claim 8, wherein said steps of applying a coating and stamping or printing are performed as part of an original hose manufacturing process.

11. The method for manufacturing a hose in accordance with claim 8, wherein said step of stamping or printing a logo comprises an ink processing step.
